(19) United States
(12) Patent Application Publication
(10) Pub. No.: US 2008/0252110 A1
(43) Pub. Date: Oct. 16, 2008

(54) CHILD SEAT

(75) Inventor: Michael Vallentin, Offenbach (DE)

Correspondence Address: RANKIN, HILL & CLARK LLP, 925 EUCLID AVENUE, SUITE 700, CLEVELAND, OH, 44115-1405, US

(73) Assignee: HONDA MOTOR CO., LTD., Tokyo (JP)

(21) Appl. No.: 12/053,828

(22) Filed: Mar. 24, 2008

(30) Foreign Application Priority Data
Apr. 12, 2007 (DE) P102007017351.4

(51) Int. Cl. B60N 2/28; A47D 13/02

(52) U.S. Cl. 297/183.3

(57) ABSTRACT

A child seat to be placed on a vehicle seat comprises a child seat body for accommodating an infant; and a handle bar for carrying the child seat. Said handle bar is configured to turn to a desired position relative to said child seat body and be fixed at the desired position. Said handle bar has a first engagement part that is attachable to and detachable from a second engagement part installed on said vehicle seat.

### BACKGROUND OF THE INVENTION

1. Field of the Invention

The present invention relates to a child seat (including a baby seat) which is placed on a vehicle seat.

2. Description of the Related Art

A seat belt for adults of a vehicle does not match an infant. Therefore, when the infant (a child of about 0-6 years old) is put on a vehicle, the infant is put on the child seat, which is placed on a vehicle seat, and the body of the infant is fastened with a seat belt of the child seat to keep the infant safely secured.

To fasten a child seat on a vehicle seat, a seat belt of the vehicle seat may be used. In late years, to enhance the stability of the child seat, the method based on “ISO-FIX” which is an international standard that ISO (International Organization for Standardization) has standardized on a method to fasten the child seat, and a method similar to the method based on “ISO-FIX” which employs fittings, has been increasingly used.

In addition, when a baby is put on the vehicle, it is often the case that a cradle-type child seat is used. When the cradle-type child seat is used, a body of a laid baby is fastened with the seat belt. Many of cradle-type child seats possess a handle bar for carrying the child seat. When the child seat is removed from the vehicle seat, the child seat can be carried with the handle bar. For example, U.S. Pat. No. 6,695,400 discloses the technology.

However, in the technology of the above patent, when the child seat is fastened on the vehicle seat with fittings, it is necessary to give special consideration to position the handle bar, and a problem often arises that a handle bar is obstructive.

Therefore, it would be desirable to provide a child seat with a handle bar that is not obstructive when the child seat is fixed on the vehicle seat with fittings.

### SUMMARY OF THE INVENTION

In one aspect of the present invention, there is provided a child seat (CS) to be placed on a vehicle seat (2) comprising:

a child seat body (1) for accommodating an infant; and

a handle bar (11) for carrying the child seat (CS), wherein said handle bar (11) is configured to turn to a desired position relative to said child seat body (1) and be fixed at the desired position, wherein said handle bar (11) has a first engagement part (12) that is attachable to and detachable from a second engagement part (21) installed on said vehicle seat (2).

### BRIEF DESCRIPTION OF THE DRAWINGS

FIG. 1 is a figure to show a total constitution including a child seat placed on a vehicle seat;

FIG. 2A is a figure which shows a state of a child seat being carried by a user; FIG. 2B is a figure which shows a state of a child seat when it is installed on a vehicle seat;

FIG. 3A-3C are sectional views taken along line A-A of FIG. 2A; FIG. 3A shows a handle bar which a first engagement part is stowed in; FIG. 3B shows the handle bar 11 from a part of which the first engagement part 12 comes out; FIG. 3C shows the handle bar which the first engagement part sticks out from till the last;

FIG. 4A is a sectional view taken along line B-B of FIG. 3A; FIG. 4B is a figure which shows a state when a button is pushed from a state of FIG. 4A;

FIG. 5A shows the child seat CS placed on the ground G so that the child seat body 1 is approximately horizontal with respect to the ground G; FIG. 5B shows the child seat CS placed on the ground G so that the child seat body 1 is inclined with respect to the ground G. and

FIG. 6 is a perspective view of another embodiment of the child seat.

### DETAILED DESCRIPTION OF THE EXEMPLARY EMBODIMENTS

Embodiments of the present invention will be described below in detail with reference to the accompanying drawings.

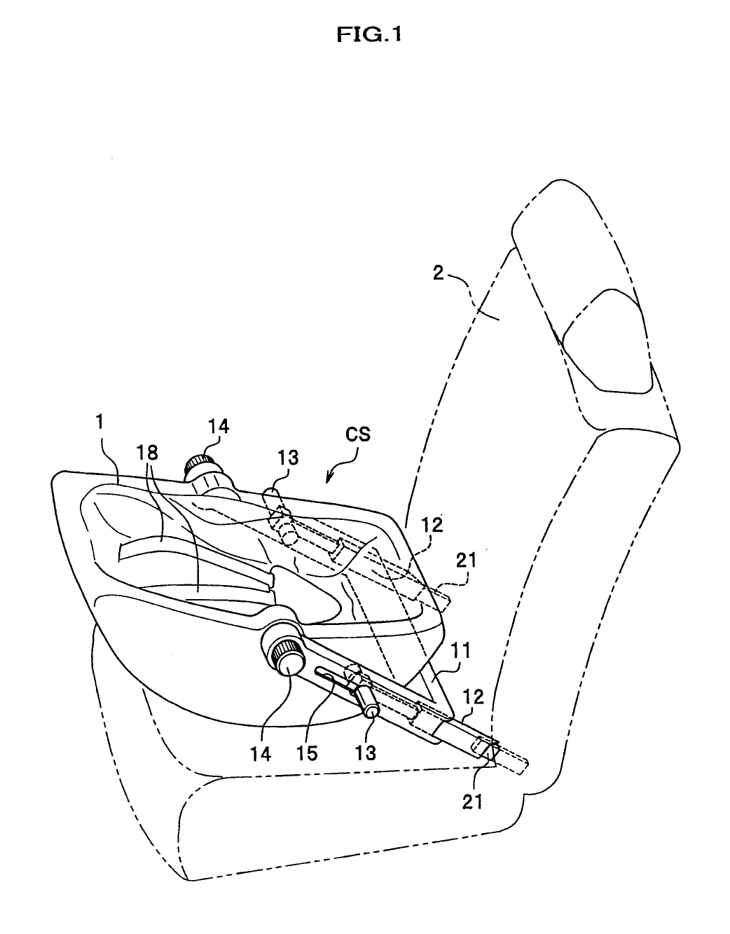

FIG. 1 is a figure to show a total constitution including a child seat placed on a vehicle seat. The child seat CS is used, when an infant is put on a vehicle. The child seat CS comprises a child seat body 1 and a handle bar 11. The child seat body 1, which is designed to accommodate an infant, comprises a seat belt 18 to fasten a body of an infant.

The handle bar 11 is adapted to be held by an adult user and enables the user to carry the child seat CS when the child seat CS is not fixed on the vehicle seat 2. The handle bar 11 comprises two first engagement parts 12, two operation parts 13 and two slits 15. The handle bar 11 is fixed on the child seat body 1 with screws 14. Only one of the engagement and other element may be described in the following.

Second engagement parts (anchorage) 21 installed on the vehicle seat 2 are fitted into the corresponding engagement parts 12. Hereby the child seat CS is fixed on the vehicle seat 2. The second engagement part 21 and the first engagement parts 12 may be made in accordance with above-mentioned “ISO-FIX” standard, and may not be made based on the “ISO-FIX” standard.

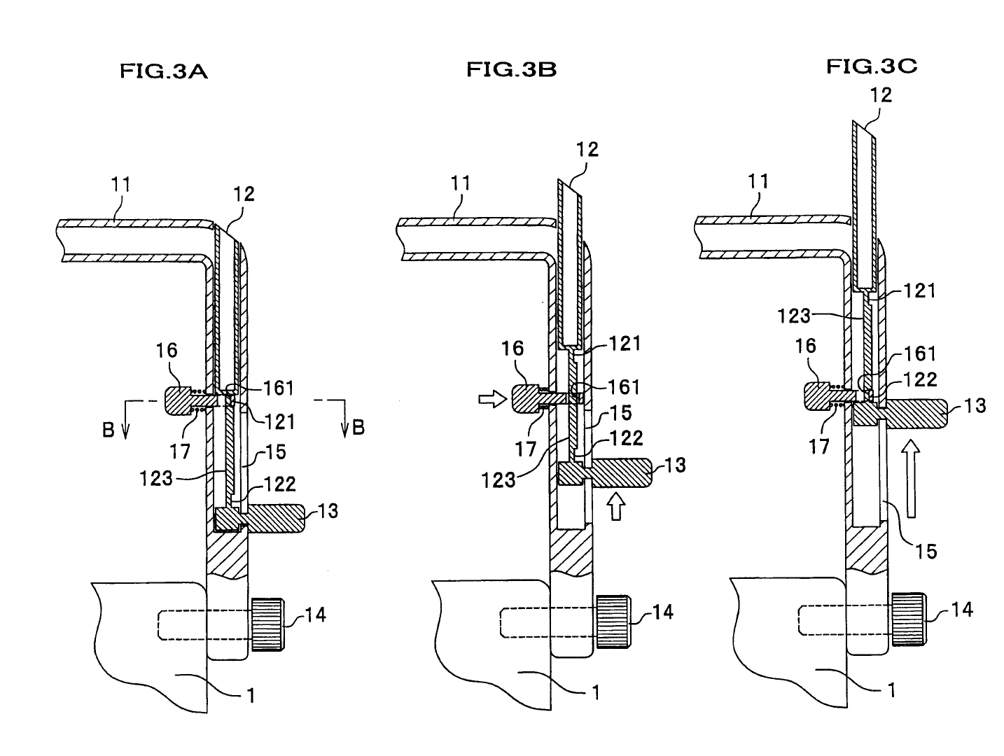

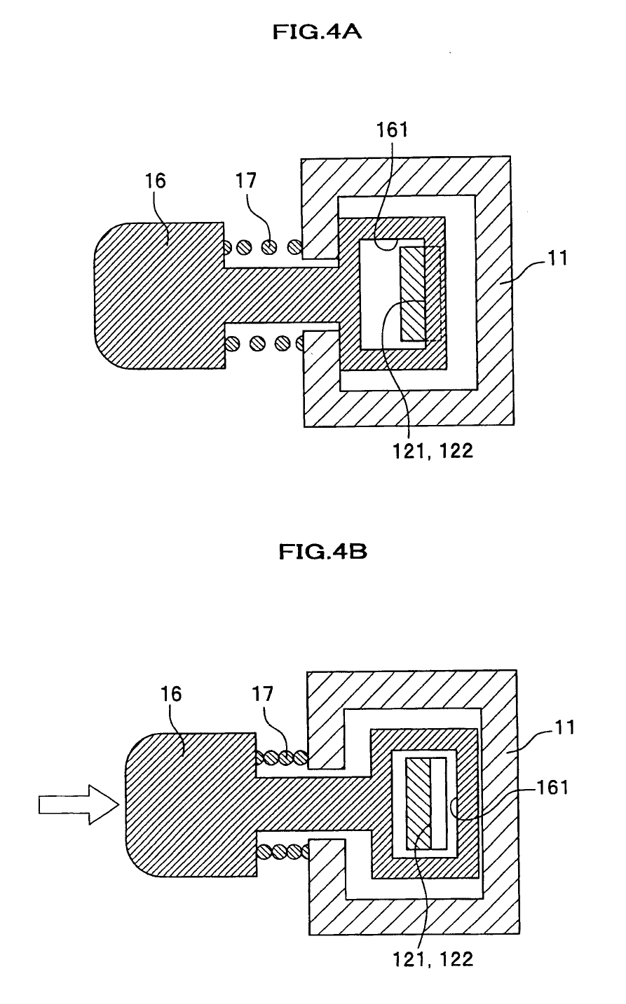

The operation parts 13 are parts to be operated by hand for a user to slide the first engagement parts 12 (the details will be described later with FIGS. 3A-3C, 4A, and 4B). Each slit 15 has a narrow gap provided in the handle bar 11. The slit 15 defines the movable range of the operation parts 13.

The handle bar 11 is fixed to the child seat body 1 with two screws 14. The screws 14 are loosened to turn the handle bar 11. The handle bar 11 may be fixed with two screws 14 at any angle against the child seat body 1 or may be fixed every predetermined angle (for example, 15 degrees). Detailed illustration and explanation about function and structure of the screws 14 are omitted because it is similar to well-known technology. In addition, other parts having the function that is similar to that of the screws 14 may be used to fix the handle bar 11 to the child seat body 1.

The vehicle seat 2 is a seat arranged on a vehicle. For example, the vehicle seat 2 is a part of a rear seat. The vehicle seat 2 has two second engagement parts 21 as mentioned above. The second engagement parts 21 are fixed to the vehicle seat 2.

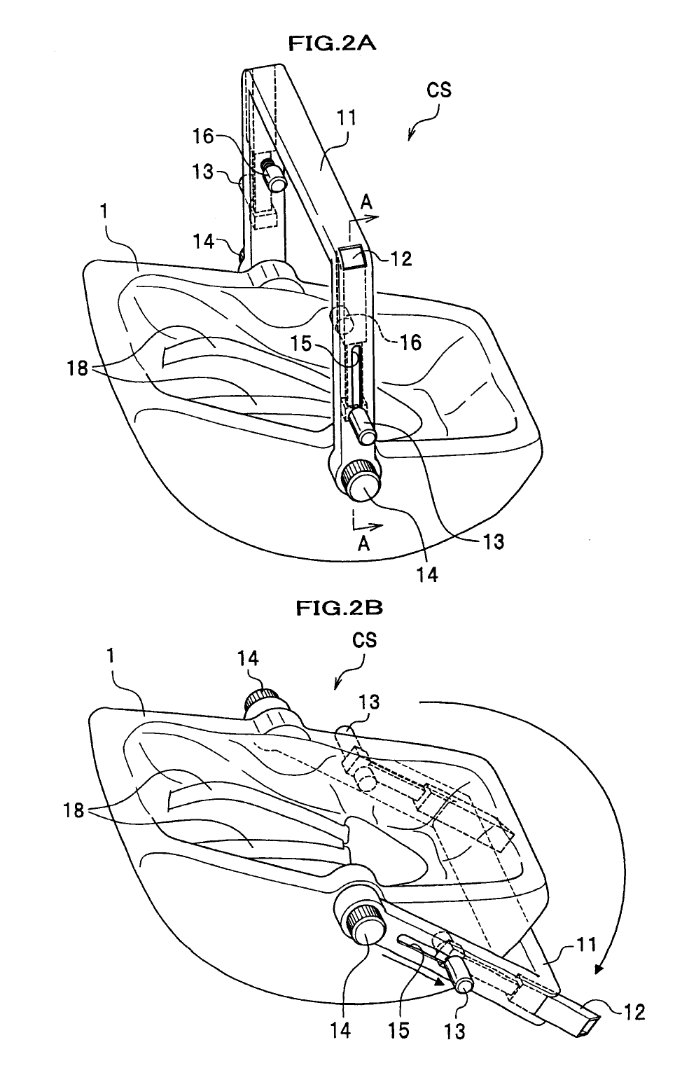

Next, a structure of the child seat will be described more in detail by referring to FIG. 2A and FIG. 2B. FIG. 2A is a figure which shows a state of the child seat being carried by a user. FIG. 2B is a figure which shows a state of the child seat when it is installed on a vehicle seat 2.

As shown in FIG. 2A, when carrying a child seat CS, a user at first looses two screws 14, turns the handle bar 11 to a convenient position, and fixes the handle bar 11 at the position by tightening two screws 14.

As shown in FIG. 2B, when placing the child seat CS on the vehicle seat 2, a user at first looses two screws 14, turns the handle bar 11 to a fixing position, and fixes the handle bar 11 by tightening two screws 14. Afterwards the user slides two first engagement parts 12 by operating two operation parts 13, and gets two first engagement parts 12 to stick out from the handle bar 11. Each of the two second engagement parts 21 of the vehicle seat 2 is fitted into two first engagement parts 12, respectively. In this way the child seat CS can be installed on the vehicle seat 2 (the details will be mentioned later with FIGS. 3A-3C, 4A and 4B). In addition, in both FIG. 2A and FIG. 2B, if it is not necessary to fix the handle bar 11, the handle bar 11 may be in a condition free to turn with the screws 14 loosened.

Next, a structure of the handle bar 11 will be described by referring to FIGS. 3A-3C. FIGS. 3A-3C are sectional views taken along line A-A of FIG. 2A. FIG. 3A shows the handle bar 11 which the first engagement part 12 is stowed in. FIG. 3B shows the handle bar 11 from which a part of the first engagement part 12 sticks out. FIG. 3C shows the handle bar 11 which the first engagement part 12 sticks out entirely.

As shown in FIG. 3A, the handle bar 11 comprises a button 16 which is pushed to slide the first engagement part 12, and a spring 17 imparting repulsion force to the pushed button 16. The button 16 and a holding member 161 to fix the first engagement part 12 are made in a single body.

The first engagement part 12 and the operation part 13 are made in a single body. Recesses 121,122 are made in a member 123 between the first engagement part 12 and the operation part 13. In FIG. 3A, the holding member 161 fits in the recess 121 and stops movement of the first engagement part 12. The first engagement part 12 is stowed entirely inside of the handle bar 11.

FIG. 4A is a sectional view taken along line B-B of FIG. 3A. As shown in FIG. 3A and FIG. 4A, the first engagement part 12 is fixed relative to the handle bar 11, because a holding member 161 fits in recess 121 (122) and the spring 17 imparts repulsion force to the pushed button 16.

FIG. 4B is a figure which shows a state when the button 16 is pushed from the state of FIG. 4A. As shown in FIG. 3B and FIG. 4B, when the button 16 is pushed down, the first engagement part 12 becomes slidable because the holding member 161 comes off recess 121 (122), which enables the first engagement part 12 to be slided by operating the operation part 13 with a finger and the first engagement part 12 sticks out from the handle bar 11.

As shown in FIG. 3C, a user continues the operation of sliding the operation part 13, if the holding member 161 fits in the recess 122, movement of the first engagement part 12 stops; the first engagement part 12 is fixed relative to the handle bar 11 (in a condition of FIG. 4A). In this way, the second engagement part 21 of the vehicle seat 2 fits into the first engagement part 12 which sticks out from the handle bar 11; therefore, the child seat CS can be fixed to the vehicle seat 2.

A user removes the child seat CS from the vehicle seat 2 by disengaging two first engagement parts 12 from two second engagement parts 21, respectively. Then the user slides the first engagement parts 12 by pushing the button 16. Afterwards the user can put the first engagement parts 12 in the handle bar 11 by operating the operation parts 13 (a state of FIG. 3A).

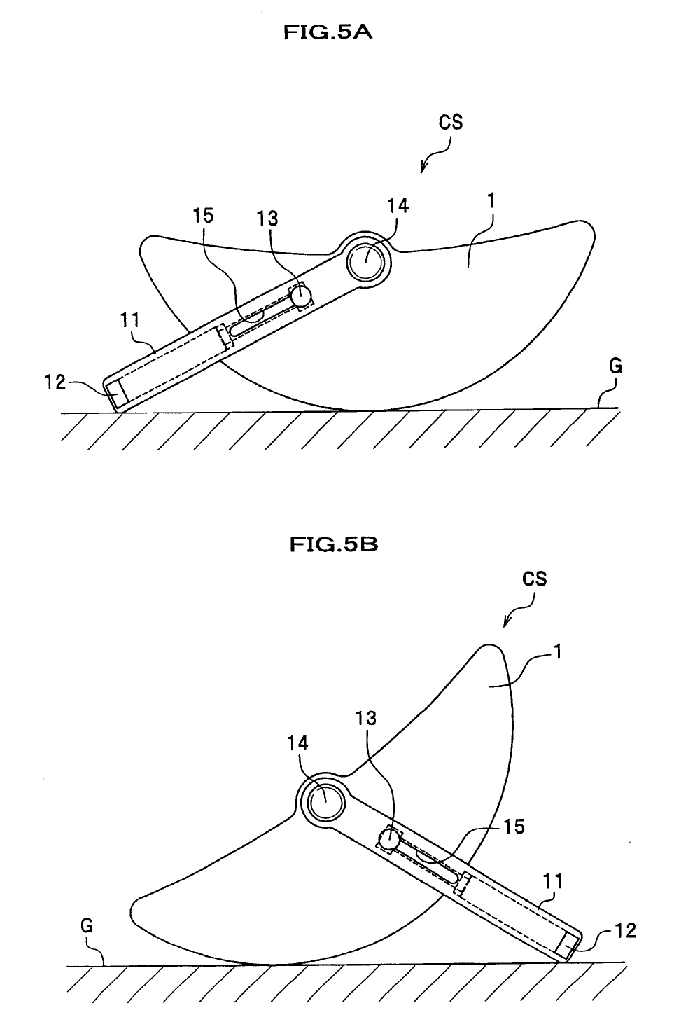

Next, the child seat which is put on the ground or a floor will be described by referring to FIG. 5A and FIG. 5B. FIG. 5A shows the child seat CS placed on the ground G so that the child seat body 1 is approximately horizontal with respect to the ground G. FIG. 5B shows the child seat CS placed on the ground G so that the child seat body 1 is inclined with respect to the ground G.

In both FIG. 5A and FIG. 5B, a user turns the handle bar 11 after loosing two screws 14 and can fix the handle bar 11 at the position by tightening two screws 14 after moving the handle bar 11 to a convenient position. Therefore, a user can put the child seat CS on the ground G in a desired state.

As described above, the child seat CS comprises two first engagement parts 12 which can be attachable to and detachable from two second engagement parts 21 of the vehicle seat 2, in the handle bar 11 which is used for carrying the child seat CS and is possible to turn and be fixed. Therefore, the handle bar 11 is not obstructive when the child seat CS is fixed on the vehicle seat 2.

In addition, the first engagement parts 12 can be stowed in the handle bar 11. Therefore, when the child seat CS is removed from the vehicle seat 2, the first engagement parts 12 are not obstructive by putting the first engagement parts 12 into the handle bar 11. Consequently, a user can use the child seat CS conveniently.

### Another Embodiment

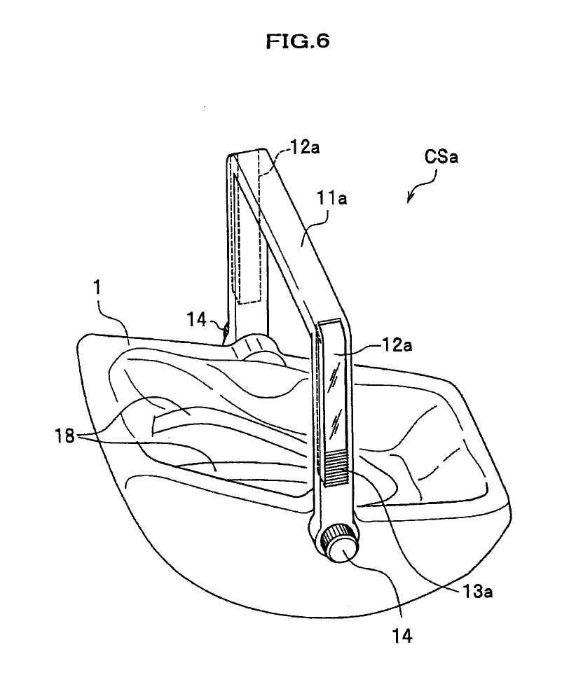

Next, another embodiment of the child seat will be described by referring to FIG. 6. FIG. 6 is a perspective view of another embodiment of the child seat. In comparison with FIG. 2A, the same reference characters are given to the same elements, and duplicate explanations are omitted.

As shown in FIG. 6, a child seat CSa comprises the child seat body 1 and a handle bar 11a. The handle bar 11a comprises first engagement parts 12a each formed with part of the outer surface of the handle bar 11a. The first engagement parts 12a comprise corresponding rugged portions 13a. The rugged portions 13a are approximately plane shape except for a small uneven surface to prevent slipping during operation. The first engagement parts 12a are formed with part of the outer surface of the handle bar 11a. In other words, the rugged portions 13a are of a more compact structure in comparison with the operation parts 13 in FIG. 2A.

Making use of two rugged portions 13a, the user has two first engagement parts 12a sliding and makes two first engagement parts 12a move further from the screws 14, so as to have two first engagement parts 12a stick out from the handle bar 11a. Each of the two second engagement parts 21 (FIG. 1) of the vehicle seat 2 (FIG. 1) is fitted into two first engagement parts 12a, respectively. In this way the child seat CSa can be installed on the vehicle seat 2 (FIG. 1).

Although it is not shown in FIG. 6, the handle bar 11a may have a mechanism such as the button 16 and the spring 17 (in FIG. 3A) to fix the first engagement parts 12a.

As described above, the child seat CSa comprises the first engagement parts 12a formed with part of the outer surface of the handle bar 11a. Therefore, a user can use the child seat CSa more conveniently because the structure of the whole handle bar 11a becomes more compact.

Explanation of exemplary embodiments has been made as above, but practicable modes of present invention are not limited to these embodiments. For example, the vehicle seat to be put the child seat on may be the seat next to the driver of a car or a seat of a vehicle other than a car.

The child seat may be fixed more to the vehicle seat by auxiliary means such as so-called top tether besides fixation for the vehicle seat by the above-mentioned first engagement part.

In addition, it can be changed about concrete constitution appropriately in the range that does not deviate from a gist of present invention.

1. A child seat placed on a vehicle seat, comprising:
a child seat body for accommodating an infant; and
a handle bar for carrying the child seat, said handle bar configured to rotate to a desired position relative to said child seat body and fixed at the desired position,
wherein said handle bar has a first engagement part that is attachable to and detachable from a second engagement part installed on said vehicle seat.

2. The child seat as claimed in claim 1, wherein said first engagement part is storable into said handle bar.

3. The child seat as claimed in claim 1, wherein said first engagement part forms part of the outer surface of the handle bar.
